(19) United States
(12) Patent Application Publication
(10) Pub. No.: US 2015/0092065 A1
(43) Pub. Date: Apr. 2, 2015

(54) LINK TRAINING IN A VIDEO PROCESSING SYSTEM

(71) Applicants: Prakash Radhakrishnan, Portland, OR (US); Sathyanarayanan Gopal, Fremont, CA (US); Pravas Pradhan, Bangalore (IN); Aruna Kumar, Bangalore (IN)

(72) Inventors: Prakash Radhakrishnan, Portland, OR (US); Sathyanarayanan Gopal, Fremont, CA (US); Pravas Pradhan, Bangalore (IN); Aruna Kumar, Bangalore (IN)

(21) Appl. No.: 14/040,044

(22) Filed: Sep. 27, 2013

(51) Int. Cl. H04N 17/00

(52) U.S. Cl. CPC H04N 17/00
USPC 348/180

(57) ABSTRACT

A method for training the lanes of a main data link includes setting an initial lane voltage swing and conducting link at the initial value, and determining if link training was successful. If link training at the initial value of lane voltage swing was not successful, the value of lane voltage swing is incremented to a predetermined value. A determination is made as to whether the predetermined value of lane voltage swing exceeds a threshold value, and link training is ended if the predetermined value of lane voltage exceeds the threshold value. If the predetermined value of lane voltage swing does not exceed the threshold value, link training is conducted at the predetermined value of lane voltage swing until link training is successful or until a predetermined number of attempts at the predetermined value of lane voltage swing fail to successfully train the link.

### TECHNICAL FIELD

The present techniques relate generally to video display and processing systems, and devices that include such systems. More particularly, the present techniques relate to decreasing power consumption in such video display and processing systems.

### BACKGROUND ART

Video processing and display systems, such as those used in computers and other electronic devices, transmit packetized video data via a data link from a source, such as a video player or computer graphics processing unit, to a sink system, which may include a display panel or recorder, at a predetermined throughput rate defined by a standard, such as the Display Port video interface standard developed by the Video Electronics Standards Association. Video processing systems are designed to meet the throughput rate of the relevant standard across a range of operating parameters, including a range of supply voltages, ambient temperatures, and process speeds.

Link training is the handshake process by which the source and sink of a video processing system synchronize. System parameters, including the number of data lanes to enable and the link rate, are determined via a link training handshake between the source and sink that occurs on the auxiliary channel (AUX). Link training is successfully completed when the sink is synchronized to the incoming data link. The throughput rate of a typical video processing/display system will be slower at slow process speeds and lower applied supply voltages, and power consumption will be relatively low under those operating conditions. Conversely, the throughput rate will be higher at faster process speeds and higher applied supply voltages, but power consumption will be increased under those operating conditions. Thus, system designers face an inherent design tradeoff between throughput rate and power consumption, i.e., higher throughput rates carry a penalty in the form of increased power consumption. Accordingly, typical video processing systems are designed to operate reliably at the slow corner (i.e., slow process speed and low supply voltage) and to accept the tradeoff of increased power consumption at the fast corner (i.e., fast process speed and higher supply voltage). Designing the systems to operate reliably at the slow corner also helps to ensure link training is successful across all operating corners. However, training the link to operate at the slow corner may not reflect actual operating conditions and thus may carry the above-referenced power consumption penalty when the system is operating outside the slow corner.

### BRIEF DESCRIPTION OF THE DRAWINGS

FIG. 1 is a block diagram of an electronic device that can decrease power consumption during link training, in accordance with embodiments;

FIG. 2 is a detail block diagram of the sink and source subsystems of the electronic device of FIG. 1;

FIGS. 3 and 4 are process flow diagrams of a method for decreasing power consumption during link training;

FIGS. 5A, 5B, and 5C are process flow diagrams of an embodiment of the method for link training in a video processing system; and

FIG. 6 is a block diagram depicting an example of a tangible, non-transitory computer-readable medium that can decrease power consumption during link training.

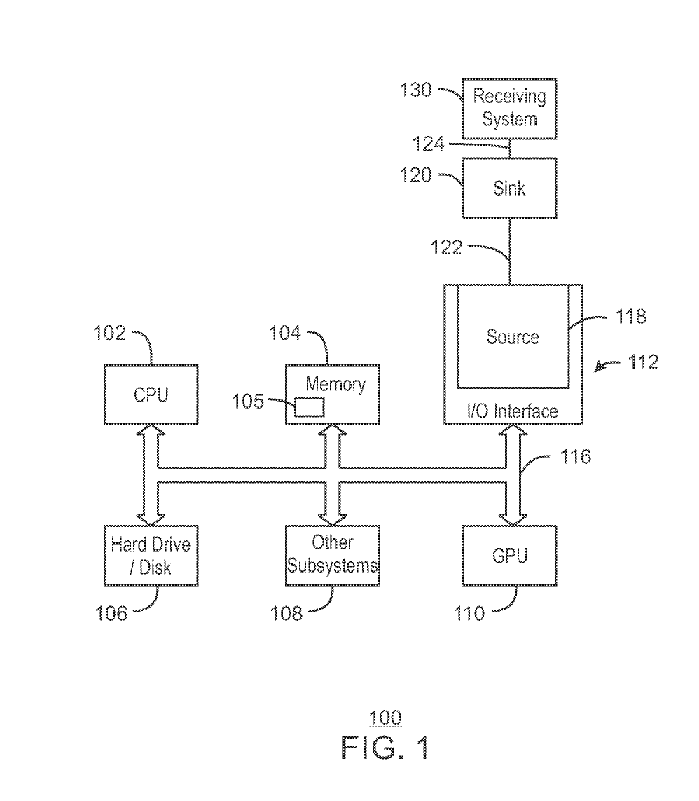

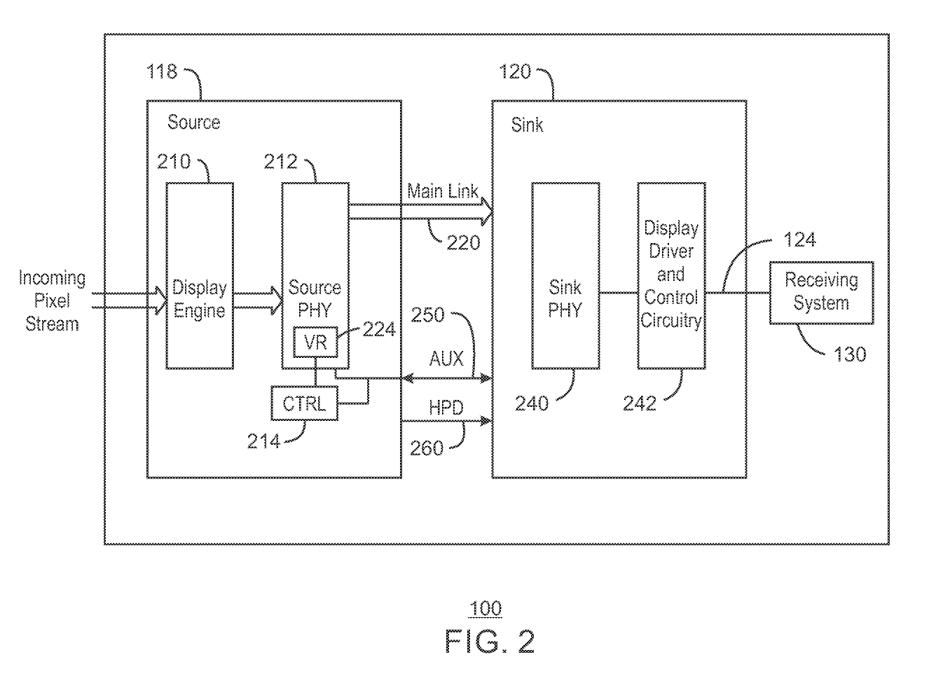

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device 100 having a video processing system that can decrease power consumption during link training. Electronic device 100 may be virtually any type of electronic device that process video data including, for example and without limitation, a computer, television, video player or receiver, gaming console, and the like. Electronic device 100 may include a central processing unit or CPU 102 and one or more memory devices 104. CPU 102 may be a conventional CPU capable of reading and executing instructions, including instructions stored in memory device 104. Memory device 104 may be configured as random access memory, read only memory, flash memory, EEPROM, removable memory such as an SD card or USB memory stick, or any combination of the foregoing. Memory device 104 includes a non-transitory medium that stores computer-readable instructions 105 that are executable by CPU 102, and which will be more particularly described hereinafter.

Electronic device 100 may also include a hard disc drive 106. Electronic device 100 may further include various other subsystems indicated at 108, including for example interface circuitry to connect peripheral devices such as a keyboard or mouse (not shown) and the like. Electronic device 100 may also include a graphics processing unit or GPU 110 for processing video data and an input/output (I/O) interface system 112. Each of CPU 102, memory 104, hard disc drive 106, subsystems 108, GPU 110 and I/O interface system 112 are interconnected via a signal bus 116, such as, for example, an ISA, EISA or SCSI bus. I/O interface system 112 includes source system 118, which will be more particularly described in connection with FIG. 2. Source system 118 is interconnected with sink system 120 via a video data bus 122, which may, in embodiments, be in the form of a connector cable, such as, for example, a connector and cable compatible with the DisplayPort video interface standard. Sink system 120 is interconnected via a video signal bus 124 to a receiving system 130, such as, for example, a television, display panel, computer monitor, video recorder or storage device, or other video display or recording element. Sink system 120 may be integral with or separate from the receiving system 130. Video signal bus 124 may, in embodiments, also be in the form of a connector cable or bus compatible with the DisplayPort video interface standard. Sink system 120 is also described in more detail in connection with FIG. 2.

FIG. 2 is a block diagram showing additional detail of the source and sink systems 118 and 120, respectively, in accordance with embodiments. Source system 118 includes display engine 210, the source physical layer or source PHY 212, and controller 214. Display engine 210 formats the pixel stream into packetized video data, dependent, at least in part upon and to be compatible with, the characteristics of the display device 130. Source PHY 212 transmits or otherwise provides the formatted video data via main link 220 to sink system 120. Source PHY 212 includes voltage regulator VR 224 that establishes a regulated operating or supply voltage for source PHY 212. Source system 118 also includes controller CTRL 230, such as, for example, a JTAG controller. CTRL 230 may be separate from or integral with source system 118 and/or source PHY 212.

Sink system 120 includes sink physical layer or sink PHY 240 and display driver and control circuitry 242. Sink PHY 240 receives the formatted video data from source 118 and formats the data for display, including regenerating the timing, clock and other signals or parameters to synchronize the received video data. Display driver and control circuitry 242 transfers the frames of video data to receiving system 130 in accordance with the timing parameters generated by source PHY 212, and includes logic to control the operation of receiving system 130. In embodiments, receiving system 130 may be a television or other display element or panel, a video recorder, or other device configured to receive, store, display, and/or otherwise process video data. Source and Sink systems 118 and 120, respectively, may also exchange control and other signals via AUX channel 250, which is a half-duplex bidirectional link. HPD signal link 260 is a hot plug detect line by which sink system 120 communicates to source system 118 that a receiving device has been connected to sink system 120.

Link training may be initiated upon a hot plug detect signal issued by sink system 120 that is transferred via HPD signal link 260 to source system 118. Link training may also be triggered by, for example, an interrupt request signal issued by sink system 120 to source system 118 via HPD signal link 260 indicating a potential loss of synchronization or at any other time the main link 220 has lost synchronization. Once initiated, link training determines the operating configuration and parameters of the main link 220, including the number of lanes to enable and the link rate, dependent at least in part upon the characteristics of sink system 120 and receiving system 130.

In embodiments, as will be further described hereinafter, link training of main link 220 may further include setting an initial value for the voltage swing on the lanes of main link 220 as provided by VR 224 and, thus, the initial lane voltage swing at which source PHY 212 transmits or otherwise provides the formatted video data to sink system 120 and receiving system 130. The initial lane voltage swing on main link 220 may, in embodiments, be established by CPU 102 executing instructions 105 to control the voltage level output by VR 224. In other embodiments, the initial lane voltage swing on main link 220 may be set by logic within CTRL 30 which, in turn, controls the voltage level output by VR 224. While, in still other embodiments, the initial lane voltage swing on main link 220 may be set by any combination of CPU 102, instructions 105, and CTRL 30. If link training is successful at the initial voltage, normal operation of electronic device 100 commences. If link training is not successful, CPU 102 executing instructions 105 or CTRL 30, or a combination thereof, read the information communicated by the sink PHY 120 to the source PHY 118 via the AUX channel 250 and, dependent at least in part thereon, increases the lane voltage swing provided by VR 224 to source PHY 118 thereby relaxing the timing constraints. The process is then repeated until link training is successful or until link training fails at a value above a threshold for the lane voltage swing.

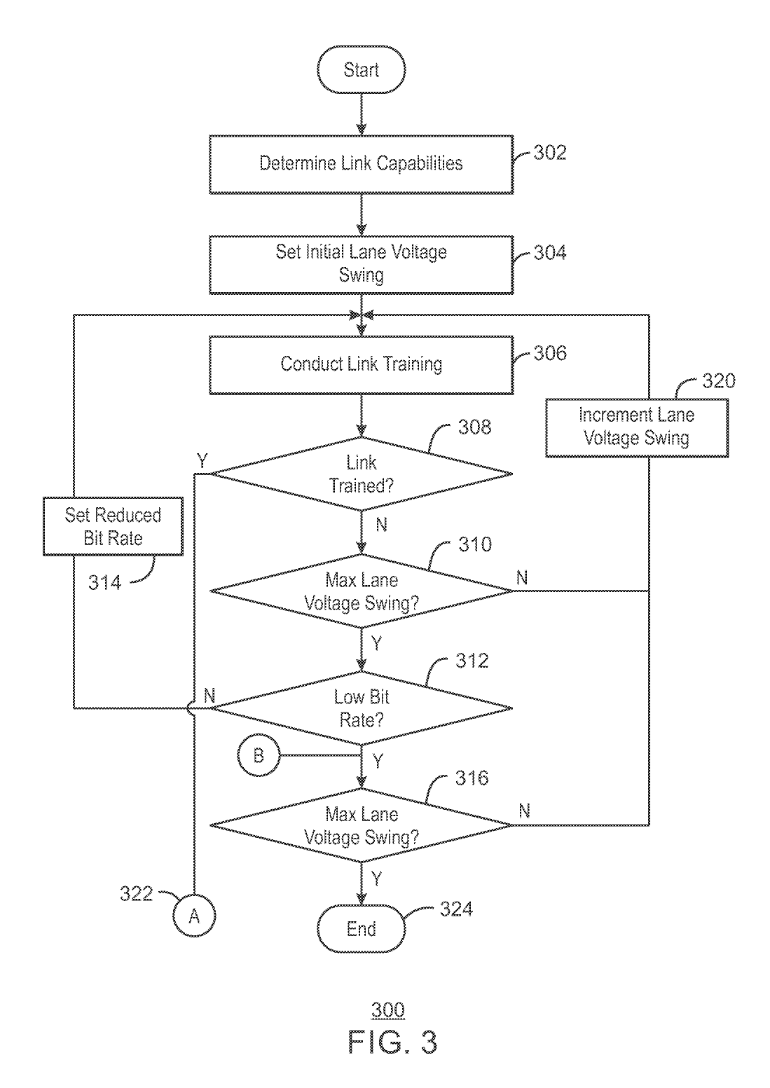

FIG. 3 is a process flow diagram illustrating a method that can decrease power consumption during link training in a video processing system, in accordance with embodiments. In various embodiments, method 300 is performed by, for example, an electronic device such as electronic device 100 of FIG. 1. The method 300 may be embodied as executable instructions included in the firmware, operating system, or other operating instructions stored in or provided to such an electronic device, and may be, for example, embodied as machine-readable instructions stored in the memory of the electronic device, such as instructions 105 stored in memory 104 of electronic device 100 of FIG. 1. Method 300 includes determining sink capabilities 302, setting an initial main link lane voltage swing 304, conducting link training 306, determining whether link training was successful 308, detecting the main link lane voltage 310, checking for low bit rate 312, setting reduced bit rate 314, checking for lane voltage above a threshold 316, increasing lane voltage 320, junction A at block 322, and end 324.

Determining sink capabilities at block 302 includes determining the collective capabilities, including throughput rate, memory/buffer size, etc., of the sink system, such as sink system 120, the receiving system, such as receiving system 130, and the interconnection between the source and sink systems, and between the sink and receiving systems, such as buses 122 and 124.

At block 304, an initial value for main link lane voltage swing is set dependent at least in part upon the characteristics of the link determined at block 302. Other link training parameters are established at block 304 that may also be dependent at least in part upon the characteristics of the link determined at block 302, including the initial main link bit rate. The main link initial lane voltage swing is established, in embodiments, by VR 224 supplying the initial main link lane voltage swing to the lanes of main link 220 based upon one or more control signals from CTRL 230 and/or CPU 102 executing instructions 105 stored in memory 104. In embodiments, the main link lane voltage swing is set to an initial level below a threshold, dependent at least in part upon the characteristics of the link, as determined at block 302. The initial main link lane voltage may, in other embodiments, be set to the output voltage of VR 224 that is below a threshold.

At block 306, link training is conducted. As will be understood by one of ordinary skill in the art, link training generally includes adjusting drive settings and bit rates until the link is successfully trained, i.e., bit lock and signal lock are achieved on each of the lanes to be configured and any suitable number of lanes are symbol locked with inter-lane alignment. Whether link training was successful may be determined via the AUX channel 250, such as, for example, source system 118 reading the status registers (not shown) of at least one of sink 120 and receiving system 130. The details of the entire link training process are outside the scope of this disclosure and thus are not presented herein.

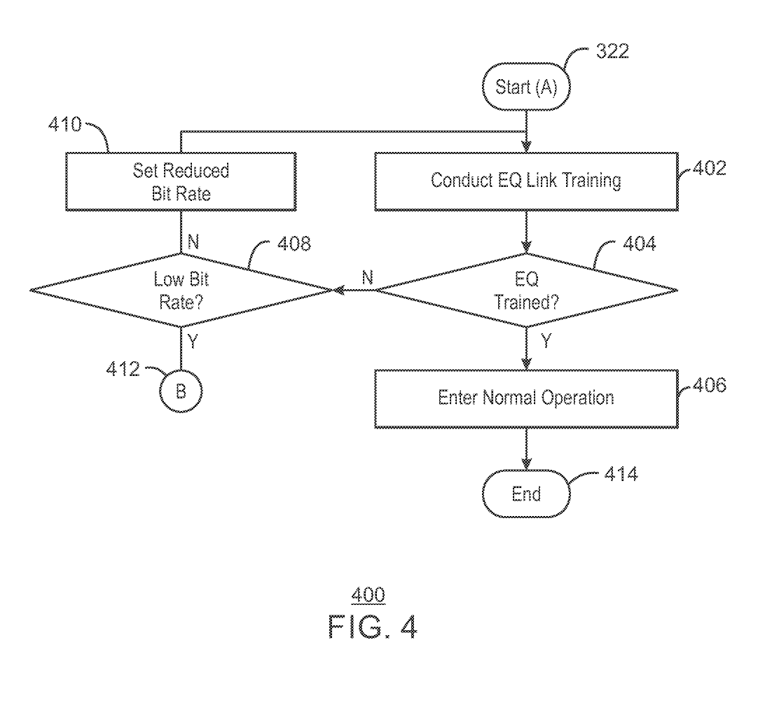

If link training is determined at block 308 to have been successfully completed at the initial value of main link lane voltage swing established at block 304, or at a subsequent value set at block 320, link training transitions at block 322 to EQ link training method 400, as will be more particularly described hereinafter with reference to FIG. 4. If link training is not successfully completed at the initial value of main link lane voltage swing established at block 304, the main link lane voltage swing is detected at block 310 to determine whether the main link lane voltage swing is set to a value equal to or above a threshold. In embodiments, it may also be determined at block 310 whether the current value of link lane voltage swing has previously failed link training a predetermined number of times. If the current main link lane voltage swing is not at a value above a threshold, or in embodiments link training has failed a predetermined number of times at the current main link lane voltage swing, the current main link lane voltage swing is increased or incremented by a predetermined amount and link training is again attempted at block 306. Conversely, if the current main link lane voltage swing is at a value above a threshold, or link training has failed a predetermined number of times at the current main link lane voltage swing, it is determined at block 312 if the bit rate is currently set to a predetermined value below a threshold. If the current bit rate is not at the predetermined value below a threshold, then the bit rate is reduced at block 314 and link training is again attempted at block 306.

If it is determined at block 312 that the current bit rate is below a predetermined value, the current main link lane voltage swing is detected at block 316 to determine if the current main link lane voltage swing is above a predetermined value. If the current main link lane voltage swing is above a predetermined value, link training has failed and link training ends at block 324. Conversely, if the current link lane voltage swing is not above a predetermined value, the main link lane voltage swing is increased or incremented by any suitable amount at block 320, and link training is again attempted at block 306.

As shown in the process flow diagram of FIG. 3, the process of incrementing or increasing the main link lane voltage swing (i.e., blocks 306, 308, 310 and 320) is iteratively performed within a set bit rate until a value for the link lane voltage swing is above a threshold or until link training is successful. If the value for the link lane voltage swing is above a threshold without successful completion of link training, the bit rate is reduced (i.e., block 314) and the process of incrementing or increasing the main link lane voltage swing (i.e., blocks 306, 308, 310 and 320) is iteratively performed at the reduced bit rate until the value for the link lane voltage swing is above a threshold or until link training is successful. Upon successful completion of the link training method 300, the method of EQ link training 400 is commenced.

FIG. 4 is a process flow diagram illustrating a method for EQ link training for reducing power consumption in a video processing system, in accordance with embodiments. In various embodiments, method 400 is also performed by, for example, an electronic device such as electronic device 100 of FIG. 1. The method 400 may be embodied as machine-readable instructions included in the firmware, operating system, or other operating instructions stored in or provided to such an electronic device, and may be, for example, embodied as machine-readable instructions stored in the memory of the electronic device, such as instructions 105 stored in memory 104 of electronic device 100 of FIG. 1. Method 400 includes conducting EQ link training 402, EQ link trained determination 404, enter normal operating state 406, low bit rate check 408, set reduced bit rate 410, junction B at block 412, and end block 414.

Conduct EQ link training at block 402 includes, for example and as will be known to one of ordinary skill in the art, transmitting test patterns, such as, for example, test pattern set 2 or test pattern set 3, over the main link and writing certain initiating data bytes via the AUX channel. The details of the entire EQ link training process are beyond the scope of this disclosure and thus are not presented here.

The EQ link trained determination at block 404 determines whether EQ link training was successful. If so, normal operation of the video processing system is commenced at block 406 and the training process ends at block 414. If the EQ link training was not successful, the low bit rate check at block 408 is performed to determine whether the lowest bit rate has been reached. If the lowest bit rate has been reached, method 400 at junction B or block 412 returns to the link training method 300 illustrated in FIG. 3 at junction B. If the lowest bit rate has not been reached, the bit rate is reduced at block 410, and EQ link training is then repeated at the reduced bit rate value.

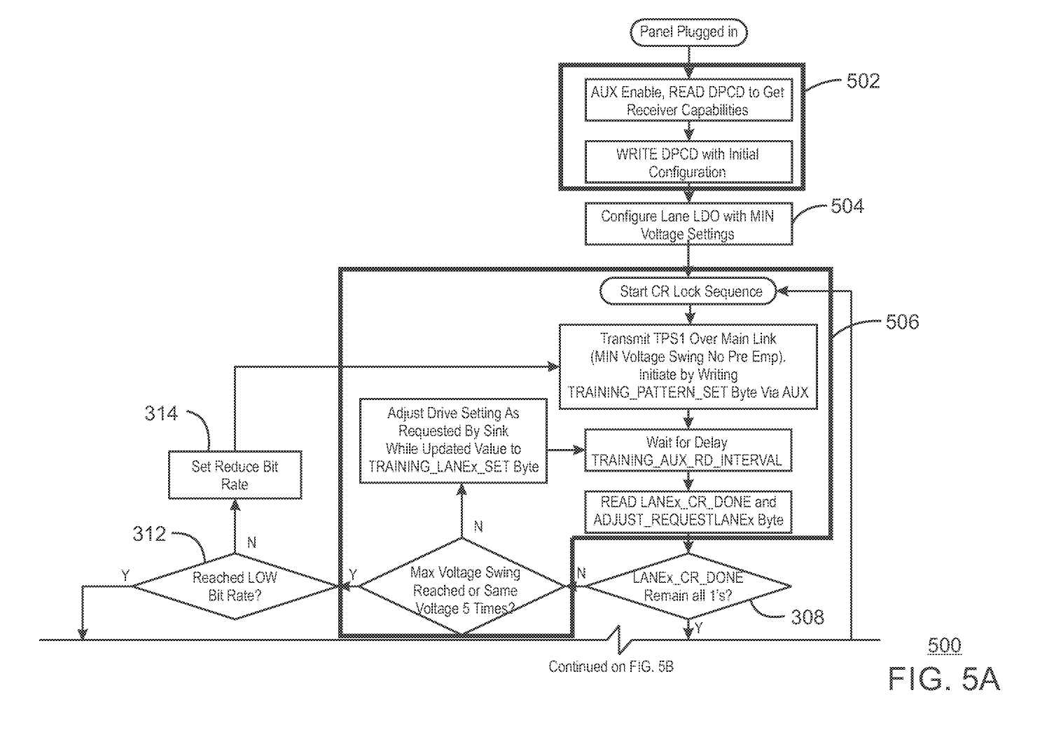

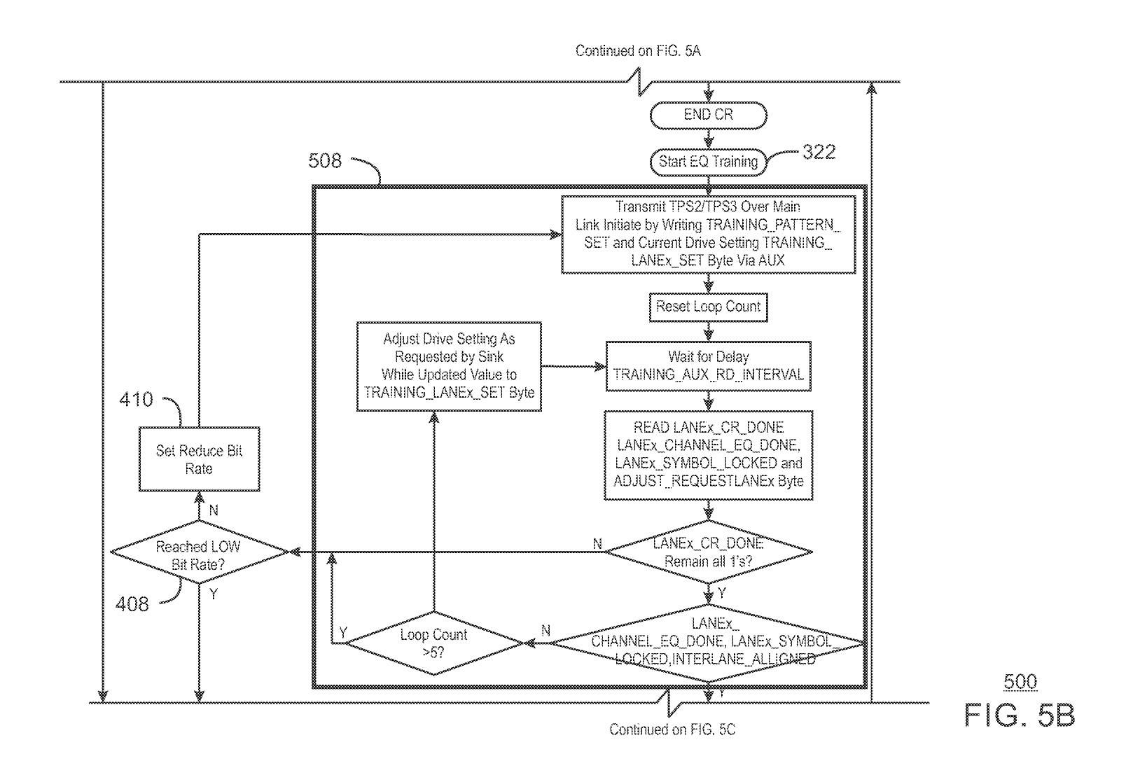

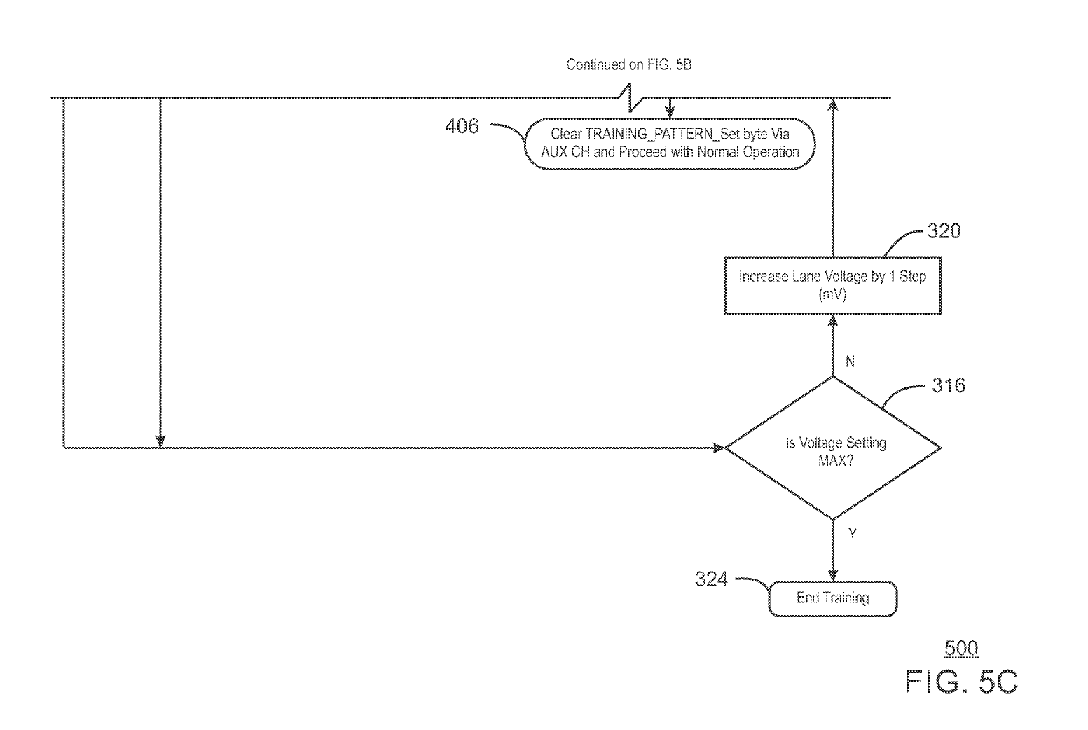

FIGS. 5A, 5B, and 5C are process flow diagrams illustrating an embodiment of a method for link training in a video processing system. More particularly, FIGS. 5A, 5B, and 5C illustrate a method 500 for link training for power optimization in a system compatible with the Display Port video interface standard. In such embodiments, method 500 may be performed by, for example, an electronic device such as electronic device 100 of FIG. 1. The method 500 may be embodied as machine-readable instructions included in the firmware, operating system, or other operating instructions stored in or provided to such an electronic device, and may be, for example, embodied as machine-readable instructions stored in the memory of the electronic device, such as instructions 105 stored in memory 104 of electronic device 100 of FIG. 1. It should be particularly noted that FIGS. 5A, 5B, 5C and the method 500 illustrated thereby are directed, as stated above, to a Display Port-compatible embodiment, and are provided to illustrate the implementation of the methods described herein related to a Display Port-compatible system.

Method 500 includes determine link capabilities 502, set initial lane voltage swing 504, conduct link training 506, and conduct EQ link training and link training check 508. Determine link capabilities 502, which generally corresponds to determine link capabilities 302 of the embodiment illustrated in FIG. 3, includes sub-blocks (not referenced) specific to the Display Port-compatible embodiment and which will be understood by those of ordinary skill in the art, and, thus, the sub-blocks are not described in detail. Set initial lane voltage swing 504, which generally corresponds to set initial lane voltage swing 304 of the embodiment illustrated in FIG. 3, is also specific to the Display Port-compatible embodiment and will be understood by those of ordinary skill in the art, and, thus, is also not described in detail. Conduct link training 506, which generally corresponds to conduct link training 306 of the embodiment illustrated in FIG. 3, also includes sub-blocks that are specific to the Display Port-compatible embodiment and which will be understood by those of ordinary skill in the art, and, accordingly, are not described in detail. Conduct EQ link training 508, which generally corresponds to conduct EQ link training 402 of the embodiment illustrated in FIG. 4, includes a plurality of sub-blocks that are specific to the Display Port-compatible embodiment and which will be understood by those of ordinary skill in the art, and, accordingly, are not described in detail.

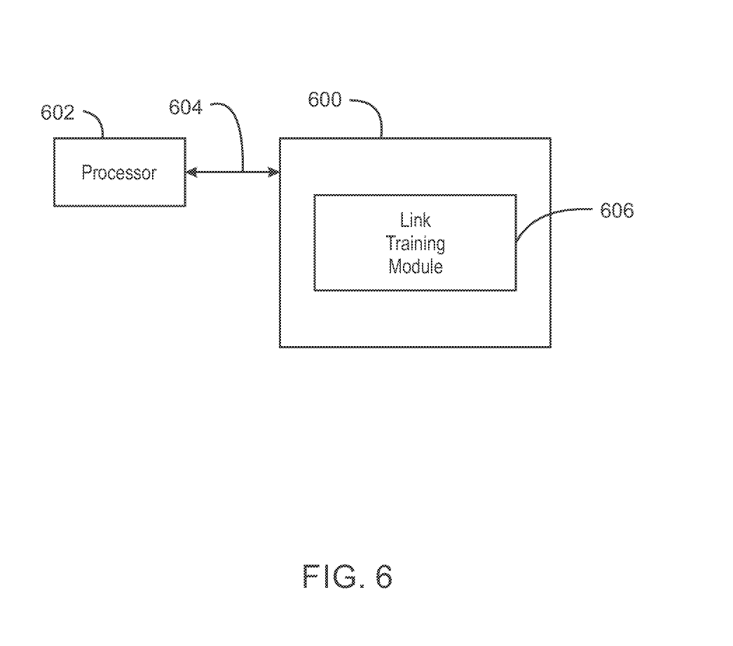

FIG. 6 is a block diagram depicting an example of a tangible, non-transitory computer-readable medium that can decrease power consumption during link training. The tangible, non-transitory, computer-readable medium 600 may be accessed by a processor 602 over a computer interconnect 604. Furthermore, the tangible, non-transitory, computer-readable medium 600 may include code to direct the processor 602 to perform the operations of the current method.

The various software components discussed herein may be stored on the tangible, non-transitory, computer-readable medium 600, as indicated in FIG. 6. For example, a link training module 606 may be adapted to direct the processor 602 to set an initial value for a lane voltage swing, conduct link training of the main data link at the initial value of lane voltage swing, and determine if link training was successful. If link training at the initial value of lane voltage swing was not successful, the link training module 606 can increment the value of lane voltage swing to a predetermined value, determine whether the predetermined value of lane voltage swing exceeds threshold value, and end link training if the predetermined value of lane voltage exceeds the threshold value. If the predetermined value of lane voltage swing does not exceed the threshold value, the link training module 606 can conduct link training at the predetermined value of lane voltage swing until link training is successful or until a predetermined number of attempts at the predetermined value of lane voltage swing fail to successfully train the link. It is to be understood that any number of additional software components not shown in FIG. 6 may be included within the tangible, non-transitory, computer-readable medium 600, depending on the specific application.

### EXAMPLE 1

An electronic device is provided herein that includes a source system for the processing of video data. The electronic device trains the main video data link at an initial main link lane voltage swing level, and in some embodiments at a value for the main link lane voltage swing that is below a threshold. If link training is not successful at the initial main link lane voltage swing level, the electronic device iteratively increases the main link lane voltage swing level until link training is successful or until link training fails at the value for the main link lane voltage swing above a threshold.

In some embodiments, the electronic device includes a voltage regulator, wherein the voltage regulator provides the voltage for the main link lane voltage swing. In some embodiments, the initial main link lane voltage swing can be below a threshold value. In addition, the electronic device can include at least one of a controller having logic and a microprocessor executing instructions that cause the voltage regulator to provide the initial main link lane voltage swing and to increment the main link lane voltage swing.

### EXAMPLE 2

A method for the link training that reduces power consumption is provided herein. The method includes setting an initial value for the main link lane voltage swing and attempting link training at that initial value. If link training is not successful at the initial main link lane voltage swing value, the method iteratively increases the main link lane voltage swing value until link training is successful or until link training fails at the value for the main link lane voltage swing that is above a threshold.

In some embodiments, the method can include setting an initial bit rate, and conducting the link training of the main data link at the initial value of voltage swing at the initial bit rate. In addition, the method may include decrementing the initial bit rate to a current bit rate when the current value of voltage swing is equal to the threshold value of voltage swing. In some embodiments, the method can also include determining whether the link training has failed a predetermined number of times at the current value of the voltage swing, and, if so, incrementing the current value of the voltage swing.

### EXAMPLE 3

At least one machine readable medium is provided herein. The readable medium includes instructions stored therein that, in response to being executed on an electronic device, cause the electronic device to reduce power consumption during link training of the main video data link of an electronic device. The instructions include causing the electronic device to set an initial value for the main link lane voltage swing and to conduct link training at that initial value. If link training is not successful at the initial main link lane voltage swing value, the instructions cause the electronic device to iteratively increase the main link lane voltage swing value until link training is successful or until link training fails at the value for the main link lane voltage swing that is above a threshold.

In some embodiments, the instructions can cause the electronic device to conduct an EQ training of the main data link. The instructions may also cause the electronic device to determine during the EQ training of the main link whether a low bit rate has been reached and, if not, to iteratively reduce the bit rate and conduct EQ training until one of EQ training is successful, or a predetermined low bit rate is reached at the value above a threshold of the lane voltage swing.

It is to be understood that specifics in the aforementioned examples may be used anywhere in one or more embodiments. For instance, all optional features of exemplary devices described above may also be implemented with respect to any of the other exemplary devices and/or the method described herein. Furthermore, although flow diagrams and/or state diagrams may have been used herein to describe embodiments, the present techniques are not limited to those diagrams or to their corresponding descriptions. For example, the illustrated flow need not move through each box or state or in exactly the same order as depicted and described.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An electronic device, comprising:
a source system for processing video data;
a main link having a plurality of lanes, the main link carrying the video data from the source system to a sink system; and
wherein the electronic device is configured to apply an initial main link lane voltage swing to the main link for link training and, if link training is not successful at the initial voltage, the electronic device being further configured to iteratively increment the main link lane voltage swing and conduct link training until link training is successful.

2. The electronic device of claim 1, wherein the initial main link lane voltage swing is a value below a threshold.

3. The electronic device of claim 2, further comprising a voltage regulator, the voltage regulator providing the voltage for the main link lane voltage swing.

4. The electronic device of claim 3, further comprising at least one of a controller having logic and a microprocessor executing instructions that cause the voltage regulator to provide the initial main link lane voltage swing and to increment the main link lane voltage swing.

5. The electronic device of claim 1, wherein the electronic device further applies an initial bit rate to the main link lanes for link training.

6. The electronic device of claim 5, wherein during link training the bit rate is held constant as the main link lane voltage swing is incremented.

7. The electronic device of claim 6, wherein during link training the bit rate is reduced upon one of a predetermined number of link training failures occurring at a predetermined value of main link lane voltage and a link training failure occurring at a threshold value of main link lane voltage swing.

8. The electronic device of claim 1, further comprising a receiving system.

9. The electronic device of claim 8, wherein the sink system is integral with the receiving system.

10. A method for training a main data link in a video processing system, the main data link having at least one lane, the method comprising:
setting an initial value for a voltage swing of the lanes of the main data link;
conducting link training of the main data link at the initial value of voltage swing;
determining if the link training was successful;
entering a normal operation mode of the video processing system if link training was successful; and
if link training was not successful at the initial value of voltage swing, iteratively:
incrementing the value of voltage swing to a current value;
conducting link training;
determining if link training was successful;
entering the normal operation mode if link training was successful;
comparing, if link training was not successful, the current value of voltage swing to a predetermined threshold value of voltage swing;
incrementing the current value of voltage swing if the current value of voltage swing does not exceed the threshold value; and
ending link training if the current value of voltage swing exceeds the threshold value.

11. The method of claim 10, wherein the initial value of main link lane voltage swing is a value below the threshold value.

12. The method of claim 10, further comprising:
setting an initial bit rate; and
conducting the link training of the main data link at the initial value of voltage swing at the initial bit rate.

13. The method of claim 12, comprising decrementing the initial bit rate to a current bit rate when the current value of voltage swing is equal to the threshold value of voltage swing.

14. The method of claim 10, comprising determining whether the link training has failed a predetermined number of times at the current value of the voltage swing, and, if so, incrementing the current value of the voltage swing.

15. At least one non-transitory machine readable medium having instructions stored therein that, in response to being executed on an electronic device having a main video data link that includes at least one data lane, cause the electronic device to:
set an initial value for a lane voltage swing;
conduct link training of the main data link at the initial value of lane voltage swing;
determine if link training was successful; and
iteratively, if link training at the initial value of lane voltage swing was not successful:
increment the value of lane voltage swing to a predetermined value;
determine whether the predetermined value of lane voltage swing exceeds a threshold value, and end link training if the predetermined value of lane voltage exceeds the threshold value; and
if the predetermined value of lane voltage swing does not exceed the threshold value, conduct link training at the predetermined value of lane voltage swing until link training is successful or until a predetermined number of attempts at the predetermined value of lane voltage swing fail to successfully train the link.

16. The machine readable medium of claim 15, wherein the initial value for lane voltage swing is a value below the threshold value.

17. The machine readable medium of claim 15, wherein the instructions further cause the electronic device to set an initial value for a lane bit rate, and wherein conducting the link training occurs at the initial lane voltage swing value and the initial lane bit rate value.

18. The machine readable medium of claim 17, comprising decreasing the lane bit rate when the link training fails a predetermined number of times with the lane voltage swing at the threshold value.

19. The machine readable medium of claim 17, wherein the instructions further cause the electronic device to conduct an EQ training of the main data link.

20. The machine readable medium of claim 19, wherein the instructions cause the electronic device to determine during the EQ training of the main link whether a low bit rate has been reached and, if not, to iteratively reduce the bit rate and conduct EQ training until one of EQ training is successful, or a predetermined low bit rate is reached at the threshold value of the lane voltage swing.
